(19) United States
(12) Patent Application Publication
(10) Pub. No.: US 2025/0129594 A1
(43) Pub. Date: Apr. 24, 2025

(54) LEVELING DEVICE, MODULAR CLEAN ROOM AND THE DOCKING METHOD OF MODULAR CLEANROOM

(71) Applicant: PRECISION ROBOTICS (HONG KONG) LIMITED, Hong Kong (CN)

(72) Inventors: Ho Chi WONG, Hong Kong (CN); Ka Wai CHAN, Hong Kong (CN); Tak Man LEUNG, Hong Kong (CN); Lap Fung CHAN, Hong Kong (CN); Cheuk Wun CHOI, Hong Kong (CN); Danny HO, Hong Kong (CN); Fei Long CHEN, Hong Kong (CN)

(73) Assignee: PRECISION ROBOTICS (HONG KONG) LIMITED, Hong Kong (CN)

(21) Appl. No.: 18/704,940

(22) PCT Filed: Oct. 14, 2022
(86) PCT No.: PCT/CN2022/125381

§ 371 Date: Apr. 26, 2024

(30) Foreign Application Priority Data
Oct. 26, 2021 (HK) 22021041203.1

(51) Int. Cl. E04B 1/343

(52) U.S. Cl. CPC E04B 1/34352

(57) ABSTRACT

A leveling device, includes a leveling plate, a first leveling member, a second leveling member. The first leveling member and the second leveling member are both provided on the leveling plate and can level the leveling plate independently of each other. And a controller communicatively connected with said first leveling member for controlling the lifting and lowering of the first leveling member. The leveling device of the embodiment of the application enables convenient and accurate leveling of the first modular cleanroom and frees operators from complex leveling operations without altering the existing trolley.

### FIELD

The present application relates to the field of cleanroom, in particular to a leveling device, a modular cleanroom, and the docking method of the modular cleanroom.

### BACKGROUND

A cleanroom refers to a space with good tightness, where parameters such as air cleanliness, temperature, humidity, pressure, and noise are controlled as required.

The development of cleanrooms is closely related to modern industry and cutting-edge technologies. Cleanroom technology has been developing continuously as the industries of precision machinery, semiconductor, pharmacy, aerospace and medical treatment all have higher requirements for the environment. In the above fields, cleanrooms have been quite widely used.

Building a conventional cleanroom requires construction such as workshop renovation, water, and electrical equipment installation, and production equipment installation on the construction site, which is time-consuming and laborious. The level of various construction personnel and the quality of construction materials in the construction process will directly affect the quality of the finished cleanroom, and then affect the product quality due to the comparatively high requirements of the cleanroom for the degree of cleanliness. Moreover, in the process of cleanroom construction, various specialized processes cooperate, with a large amount of work, and the requirement for connection between processes is also higher, so the coordination and management ability of the construction units is also highly required.

In one embodiment, modular cleanroom emerged as the times require. By adjusting the modular cleanroom, a comprehensive cleanroom assembly system can be established for complex manufacturing processes. Different from conventional cleanrooms, modular cleanrooms rely on pre-production of cleanroom modules in factories and assembly of prefabricated modules on-site to provide an environment that can meet strict requirements for cleanroom. Therefore, modular cleanrooms are faster to build compared with conventional cleanrooms. In addition, by reconfiguring the constituent modules of the modular cleanroom system, or by reducing or expanding the modular cleanroom system, the changing needs of the production system can be met, and the process flow can be changed, reduced, or expanded. Even when the business is under adjustment, the scale needs to be reduced or the whole cleanroom needs to be removed, the modular cleanroom can also be recycled, and the waste of material will not be generated as in the conventional cleanroom.

When assembling and reconfiguring the modular cleanroom, it is necessary to adjust the position of the modular cleanroom to form a comprehensive cleanroom system for complex manufacturing processes. The position adjustment of the modular cleanroom includes docking and berthing. The modular cleanroom that needs to be adjusted leaves its original position and is transported by an automated guided vehicle (AGV) to the stationary modular cleanroom to be docked and berthed to. In the process of docking and berthing, it is necessary to level the modular cleanroom departed from the original position relative to the stationary modular cleanroom and the cleanroom system.

In heavy equipment, leveling pads are usually located under the bottom corners of the machine, and the height of each leveling pad can be adjusted manually for leveling. When it is necessary to move the modular cleanroom to organize a new production line or carry out regular maintenance, a forklift is usually used to lift the modular cleanroom and lift the leveling pads off the ground, and the modular cleanroom can move freely. In this process, the leveling pads of the moved modular cleanroom inevitably change their positions, and the level conditions of the ground at different positions are usually different, which makes the original leveling state of the moved modular cleanroom invalid. When docking or releasing the moved modular cleanroom on the forklift, re-leveling is required.

In the prior art, during leveling operation, as a forklift usually does not have leveling function and only can make the whole equipment move vertically, it is still necessary to manually adjust the leveling pads eventually, to render the leveling operation complex and inaccurate. Therefore, whether during manual docking or automatic docking, in the prior art, the alignment of the modular cleanroom can only be ensured by repeatedly and independently adjusting each leveling pad of the modular cleanroom before, during, and after docking.

### SUMMARY

In order to solve the above problems or at least partially solve the above problems, an embodiment of the present application proposes a leveling device including:
a leveling plate, a first leveling member, and a second leveling member, and
said first leveling member and said second leveling member are both provided on said leveling plate and can level said leveling plate independently of each other; and
a controller communicatively connected with said first leveling member for controlling the lifting and lowering of said first leveling member.

In one embodiment, said first leveling member includes at least three first levelers, each of which is uniformly arranged in the circumferential direction of said leveling plate;
said second leveling member includes at least three second levelers, each of which is uniformly arranged in the circumferential direction of said leveling plate;

In one embodiment, each leveler of said second leveling member is closer to the periphery of said leveling plate compared to each leveler of said first leveling member.

In one embodiment, said leveler includes:
a motor provided on said leveling plate and communicatively connected with said controller;
a lead screw being in transmission connection with said motor and moving along the axis direction of the lead screw under the drive of said motor;
and a leveling pad provided at the end of the lead screw.

In one embodiment, said leveling device further includes:
a position sensor used for acquiring the position of a trolley, and said position sensor is communicatively connected with said controller.

In one embodiment of the present application, a modular cleanroom is further provided, said modular cleanroom including said leveling device, and said leveling plate is the bottom plate of said modular cleanroom.

In one embodiment of the present application, a cleanroom system is further provided, said cleanroom system including a first modular cleanroom, a second modular cleanroom, and a trolley;

In one embodiment, said first modular cleanroom is provided with said leveling device and said leveling plate is the bottom plate of said first modular cleanroom.

In one embodiment of the present application, a cleanroom system is further provided, said cleanroom system is characterized by including a first modular cleanroom, a second modular cleanroom, and a trolley;

In one embodiment, said first modular cleanroom is provided with a leveling device and said leveling device includes:
a leveling plate and a second leveling member provided at said leveling plate, said second leveling member being used for leveling said leveling plate;

In one embodiment, said trolley is provided with a supporting platform, a first leveling member is provided at said supporting platform, and said first leveling member is configured for leveling the first modular cleanroom supported on said trolley.

In one embodiment of the present application, a docking method of a modular cleanroom is provided, which includes the steps of:
loading a first modular cleanroom on a trolley and said trolley moves next to a second modular cleanroom;
leveling said first modular cleanroom on said trolley by a first leveling member;
adjusting the height of said first modular cleanroom to be consistent with that of said second modular cleanroom on said trolley by said first leveling member;
docking said first modular cleanroom with said second modular cleanroom; and
lowering said second leveling member and said first modular cleanroom is supported on the ground.

In one embodiment, said step of loading a first modular cleanroom on a trolley includes:
raising the first leveling member;
after said trolley drives under said first modular cleanroom, lowering said first leveling member until said first modular cleanroom is supported on said trolley; and
raising the second leveling member.

The leveling device of the modular cleanroom provided by an embodiment of the present application can meet the leveling requirements of a modular cleanroom in the case of organizing a new production line or regular maintenance by independently adjusting the first leveling member and the second leveling member provided at the leveling plate of the modular cleanroom. For example, when lifting the modular cleanroom by a conveying device and docking and berthing the moved modular cleanroom to the stationary modular cleanroom, the moved modular cleanroom is inevitably misaligned to the stationary modular cleanroom due to the environmental factors of the site, as well as the shape and structural factors of the conveying device itself. For example, during moving, the leveling pad of the moved modular cleanroom inevitably alters its position, and the level conditions of the ground at different positions are usually different, which makes the original leveling state of the moved modular cleanroom invalid. When docking or releasing the moved modular cleanroom on the forklift, re-leveling is required. The moved modular cleanroom may be aligned to the stationary modular cleanroom by adjusting the first leveling member. After the alignment success is visually confirmed by the operator or automatically confirmed by sensors, the moved modular cleanroom is docked to the stationary modular cleanroom, then the second leveling member is lowered, and finally the first leveling member is raised to complete the docking.

The embodiment of the present application eliminates the problem that modular cleanrooms are difficult to align due to the lack of built-in leveling function of the conveying devices and the like by means of a leveling plate and the two sets of leveling members, and enables quick and accurate docking of modular cleanrooms.

### BRIEF DESCRIPTION OF THE DRAWINGS

In order to illustrate the embodiments of the present application more clearly, a brief description of the drawings to be used in the description of the embodiments will be given below. The drawings in the following description are merely some embodiments of the present application.

FIG. 1 is a schematic three-dimensional view of a modular cleanroom according to an embodiment of the present application;

FIG. 2 is a schematic combination view of a modular cleanroom according to the embodiment of the present application;

FIG. 3 is a schematic assembly view of a modular cleanroom according to the embodiment of the present application;

FIG. 4 is a schematic three-dimensional view of the latch of a modular cleanroom according to the embodiment of the present application;

FIG. 5 is a three-dimensional bottom view of a modular cleanroom according to the embodiment of the present application;

FIG. 6 is a bottom view of a modular cleanroom according to the embodiment of the present application;

FIG. 7 is a schematic three-dimensional view of the modular cleanroom according to the embodiment of the present application before being transported by a trolley;

FIG. 8 is a schematic side view of a modular cleanroom according to the embodiment of the present application after being pushed up from the ground by a trolley;

FIG. 9 is a flowchart of the docking method of the modular cleanroom according to the embodiment of the present application.

FIG. 10 is a sub-flow chart between steps S10 and S20 of the docking method of the modular cleanroom according to the embodiment of the present application.

### Reference Numerals

1 cleanroom system; 11 first modular cleanroom; 12 second modular cleanroom; 2 trolley; 21 supporting platform; 3. latch lock; 4 first leveling member; 41 first leveler; 411 first leveling pad; 412 first lead screw; 413 first motor; 5 second leveling member; 51 second leveler; 511 second leveling pad; 512 second lead screw; 513 second motor; 6 leveling plate.

### DETAILED DESCRIPTION

In order to make the purpose the embodiments of this application clearer, the embodiments of the present application will be explained clearly and fully in the following text in conjunction with the drawing in the embodiments of the present application. The described embodiments are merely a part of the embodiments and not all the embodiments of the present application. Based on the embodiments of the present application, all the other embodiments shall fall into the scope of protection of the present application.

The applicant found that in the case of the prior art modular cleanroom, in order to move a modular cleanroom to organize a new production line or perform regular maintenance, a conveying device such as a forklift or an automated guided vehicle is usually used to lift the modular cleanroom and lift the leveling pads off the ground, and the modular cleanroom can move freely.

However, in this process, the leveling pad of the moved modular cleanroom inevitably changes its position, and the level conditions of the ground at different positions are usually different, which makes the original leveling state of the moved modular cleanroom invalid. When docking or releasing the moved modular cleanroom on the forklift, re-leveling is required. Both forklifts and automated guided vehicles usually do not have a built-in leveling function. Therefore, it is necessary to adjust each leveling pad of a modular cleanroom independently when docking manually or automatically, to ensure the alignment of the modular cleanroom, which is time-consuming and laborious.

In view of this, the embodiment of the present application provides a leveling device, a modular cleanroom, a cleanroom system, and a docking method of the modular cleanroom.

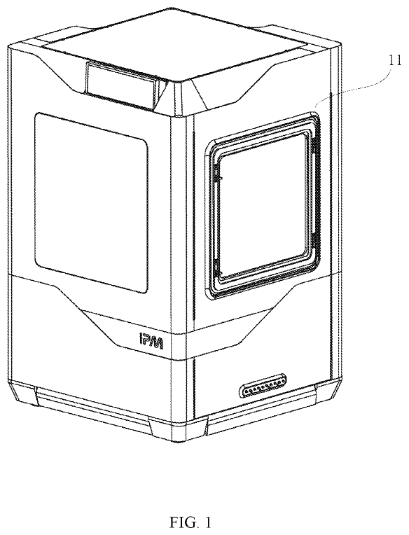

Referring to FIGS. 1-3, in one embodiment of the present application, a cleanroom system 1 includes two modular cleanrooms, namely a first modular cleanroom 11 and a second modular cleanroom 12. The first modular cleanroom 11 is docked and berthed at the second modular cleanroom 12 and is hermetically connected with the second modular cleanroom 12, to form a cleanroom system 1.

The first modular cleanroom 11 and the second modular cleanroom 12 may be identical or different as long as they can be docked and hermetically connected to form a cleanroom system 1 having corresponding functions.

Although in FIGS. 1-3, the cleanroom system 1 is shown as including two modular cleanrooms 11, 12, the cleanroom system 1 may include other numbers of modular cleanrooms and/or modular cleanrooms with different functions depending on the actual requirements for the cleanroom system 1.

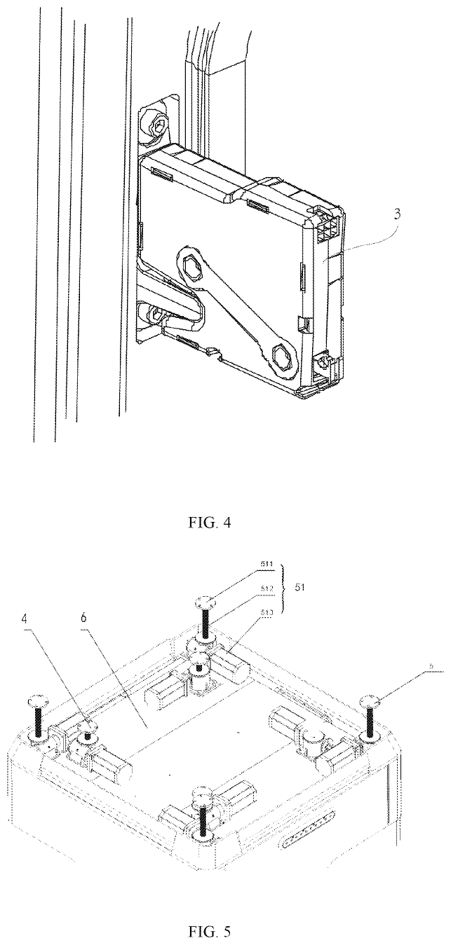

As shown in FIG. 4, the modular cleanroom may have at least one latch 3. The latch 3 is configured to lock the paired modular cleanrooms after the alignment of the modular cleanrooms, to realize the docking and berthing of the two modular cleanrooms.

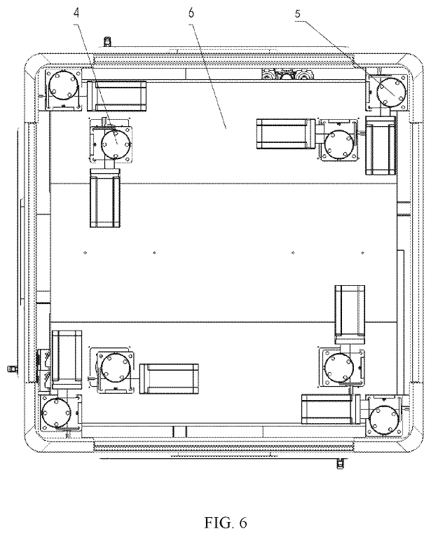

As shown in FIGS. 5 to 6, the leveling device of the embodiment of the present application includes a leveling plate 6, a first leveling member 4, a second leveling member 5, and a controller (not shown). The first leveling member 4 and the second leveling member 5 are both provided on the leveling plate 6 and can level the leveling plate independently of each other. The controller is communicatively connected with the first leveling member 4 for controlling the lifting and lowering of the first leveling member 4.

The controller may be communicatively connected with the first leveling member 4 by any known or later invented possible means including, but not limited to, wired electrical connection, optical fiber connection, Bluetooth connection, radio frequency connection, etc. The controller can adjust each first leveler 41 of the first leveling member 4 independently or synchronously adjust all of the first levelers 41.

Although in FIGS. 5 and 6, the first leveling member 4 and the second leveling member 5 each include four levelers, the present disclosure is not limited thereto. Any number of first levelers 41 or second levelers 51 greater than three may be provided as long as leveling of the leveling plate can be realized.

In one embodiment, at least three first and at least three second levelers 41 and 51 are provided, respectively. With this arrangement, since any three points determine a unique plane, accurate adjustment of the posture of the leveling plate 6 can be realized whether by adjustment of the at least three first levelers 41 or by the adjustment of the at least three second levelers 51 respectively.

Among them, at least three first levelers 41 may be uniformly arranged in the circumferential direction of the leveling plate 4. Uniformly arranging the first levelers 41 in the circumferential direction of the leveling plate makes the effects of the adjustment of each of the first levelers 41 on the posture of the leveling plate consistent, to enable simpler leveling of the leveling plate.

At least three second levelers 51 may also be provided in the same way and will not be repeated herein.

In the embodiment of the present application, each second leveler 51 of the second leveling member 5 may be closer to the periphery of the leveling plate compared to each first leveler 41 of the first leveling member 4. That is, each second leveler 51 of the second leveling member 5 is located on the outer side of the leveling plate 6, and each first leveler 41 of the first leveling member 4 is located on the inner side of the leveling plate 6. With this arrangement, when moving the modular cleanroom 11, the second levelers 51 can stay still and the first levelers 41 can be raised to form a space under the first levelers 41. By placing the trolley 2 in the space formed under the first levelers 41, and then lowering the first levelers 41, the modular cleanroom 11 can be placed on the trolley 2, and thus the transfer and docking of the modular cleanroom 11 can be easily performed. When unloading the modular cleanroom 11, the second leveling member 5 is lowered to contact the ground, and then the first leveling member 4 is raised to disengage from the trolley 2.

Each second leveler 51 of the second leveling member 5 may also be closer to the center of the leveling plate compared to each first leveler 41 of the first leveling member 4. That is, each second leveler 51 of the second leveling member 5 is located on the inner side of the leveling plate 6, and each first leveler 41 of the first leveling member 4 is located on the outer side of the leveling plate 6. With this arrangement, when moving the modular cleanroom 11, the second levelers 51 can stay still and the first levelers 41 can be raised to form a space under the first levelers 41 likewise. By placing the trolley 2 in the space formed under the first levelers 41, and then lowering the first levelers 41, the modular cleanroom 11 can be placed on the trolley 2, and thus the transfer and docking of the modular cleanroom 11 can be easily performed. When unloading the modular cleanroom 11, the second leveling member 5 located on the inner side of the leveling plate 6 is lowered to contact with the ground, then the first leveling member 4 is raised to disengage from the trolley 2, and finally, the trolley 2 is withdrawn. However, it should be noted that in this case, the platform shape of the trolley 2 may be U-shaped in the top view, and the second leveling member 5, which has come into contact with the ground, does not prevent the trolley 2 from leaving in the opposite direction to the U-shaped opening when the trolley 2 leaves.

In one embodiment, each of the levelers of the first leveling member 4 and the second leveling member 5 includes a motor, a lead screw, and leveling pads. In FIG. 5, the configuration of the second levelers 51 of the second leveling member 5 is shown.

The motor 513 is provided on the leveling plate 6 and is communicatively connected with the controller of the leveling device. The motor 513 may be driven under the control of the controller.

The lead screw 512 is in transmission connection with the motor 513, and the lead screw 512 is driven by motor 513 to move in the direction of its own axis. As shown in FIG. 5, in the case where the axial direction of the lead screw 512 is perpendicular to the leveling plate 6, the motor 513 drives the shaft of the lead screw 512 to move in a direction perpendicular to the plate surface of the leveling plate 6 under the control of the controller, to lift or lower the leveling plate 6. A leveling pad 511 is provided at the end of the lead screw 512. The leveling pad 511 is configured for contact with the ground or the trolley 2.

The structure of the first leveler 41 is the same as that of the second leveler 51 and may also include a motor 413, a lead screw 412, and leveler pads 411 not shown.

Utilizing the leveler including leveling pads, a motor and a lead screw, accurate and precise adjustment of the leveling pads position can be realized.

The first modular cleanroom 11 is leveled by the first leveling member 4, and the first modular cleanroom 11 is adjusted to the same height as the second modular cleanroom 12, to enable easy docking of the first modular cleanroom 11 with the second modular cleanroom 12. And also, the second leveling member 5 can be used to maintain the leveling state in place of the first leveling member 4 after the docking is completed. Therefore, the leveling device of the embodiment of the application enables convenient and accurate leveling of the first modular cleanroom and frees operators from complex leveling operations without altering the existing trolley.

Although the leveler in the present embodiment includes leveling pads, a motor, and a lead screw, embodiments of the present application are not limited thereto. Any other reasonable structure can be utilized as vertical movement of the leveling pad can be achieved. For example, a gear may be mounted on the drive shaft of the motor and the lead screw may be replaced with a rack. As another example, the lead screw may be replaced with a hydraulic actuator.

In one embodiment, the leveling device of the present embodiment may further include a position sensor not shown. The position sensor is configured for acquiring the position of a trolley 2, and the position sensor is communicatively connected with the controller. The position sensor of the embodiment of the present application may be any sensor capable of acquiring the position of the trolley 2 such as a visual sensor, a magnetic position sensor a photoelectric sensor. Once the approach of the trolley 2 is detected by the position sensor, this information can be sent to the controller, and the first leveler 41 is raised by the controller and the trolley 2 can get into the space under the leveling plate 6. Therefore, it is possible to enable more convenient transportation of the modular cleanroom 11.

Another embodiment of the present application further provides a modular cleanroom 11. The modular cleanroom 11 includes the above-mentioned leveling device, and the leveling plate 6 is the bottom plate of the modular cleanroom 11. Since the modular cleanroom 11 of this embodiment has the above-mentioned leveling device, even if the trolley 2 without built-in leveling function is configured, the leveling of the modular cleanroom 11 can be conveniently performed, to realize accurate docking of the modular cleanroom 11.

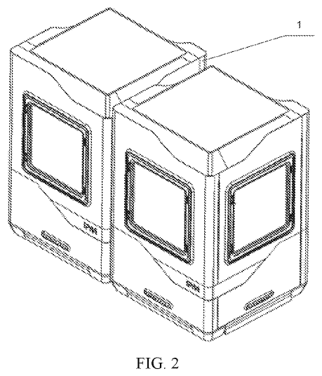

Still another embodiment of the present application also provides a cleanroom system 1. As shown in FIGS. 2-3, 5-6, the cleanroom system 1 includes a first modular cleanroom 11, a second modular cleanroom 12, and a trolley 2; the above-mentioned leveling device is provided on the first modular cleanroom 11, and the leveling plate 6 is the bottom plate of the first modular cleanroom 11. The first modular cleanroom 11 can be transported using the trolley 2, and leveled with respect to and docked with the second modular cleanroom 12 by the leveling device of the first modular cleanroom 11. After the leveling and docking are completed, the trolley leaves and is ready for the next task.

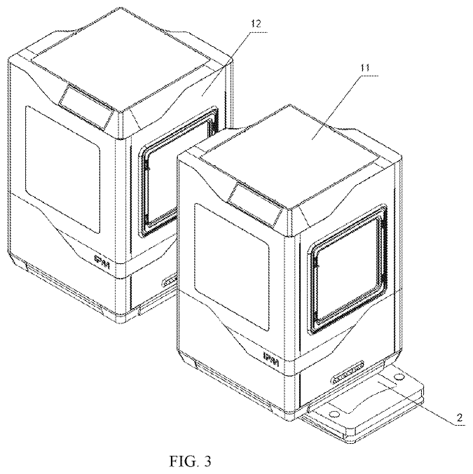

In another embodiment of the present application, a cleanroom system 1 is provided likewise. As also shown in FIGS. 2-3, the cleanroom system 1 includes a first modular cleanroom 11, a second modular cleanroom 12 and a trolley 2. The first modular cleanroom 11 is provided with a leveling device.

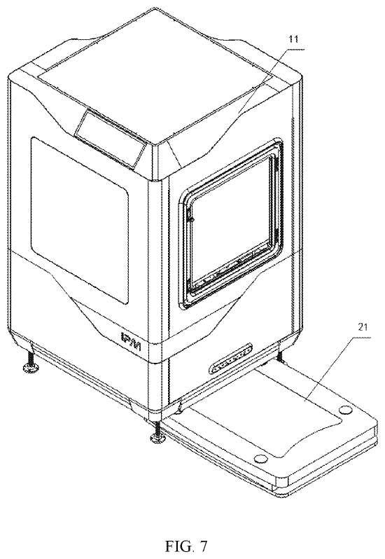

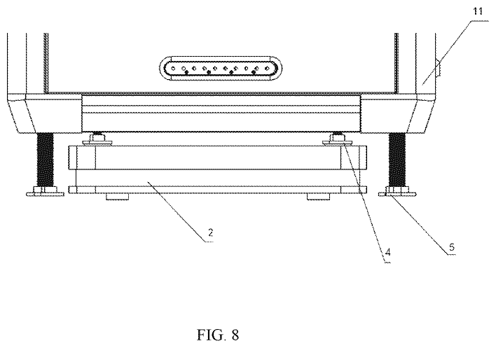

The leveling device includes a leveling plate 6 and a second leveling member 5 provided on the leveling plate 6, and the second leveling member 5 is configured for leveling the leveling plate 6. However, it is different from the above-mentioned embodiment in that: as shown in FIG. 7, the surface of the trolley 2 facing the first modular cleanroom 11 above has a supporting platform 21, the first leveling member 4 is provided on the supporting platform 21 instead of the leveling plate 6, and the first leveling member 4 is configured for leveling the first modular cleanroom 11 supported on the trolley 2.

By providing the first leveling member 4 on the supporting platform 21 of the trolley 2, each modular cleanroom 12 only needs to be provided with a second leveling member 5, and the entire cleanroom system 1 only needs to be provided with one set of first leveling member 4 on the trolley 2. The number of leveling members is further greatly reduced and the complexity of the system is reduced while maintaining the advantages of the leveling member of the embodiment of the present application, to reduce the system failure probability and improving the maintenance ease.

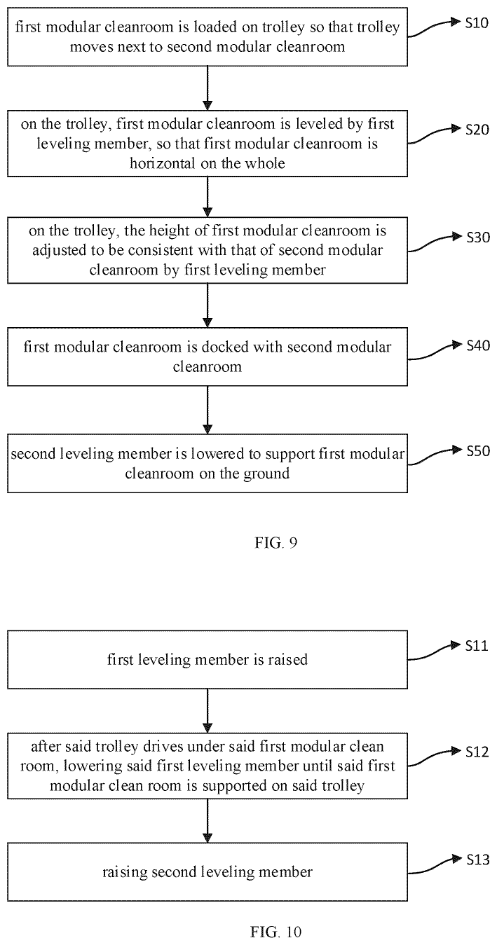

As shown in FIG. 9 and FIG. 10, another embodiment of the present application also provides a docking method of the modular cleanroom, the docking method of the modular cleanroom includes the following steps:

Step S10, loading a first modular cleanroom 11 on a trolley 2 and the trolley 2 moves next to a second modular cleanroom;

In the case where both the first leveling member 4 and the second leveling member 5 are provided at the leveling plate 6 of the first modular cleanroom 11, step S10 includes the following steps.

Step S11, the first leveling member 4 is raised. As mentioned above, the raising of the first leveling member 4 can be completed by controlling the motor to drive the lead screw by the controller. Once the approach of the trolley 2 is detected by the position sensor provided at the first modular cleanroom 11, this information can be sent to the controller to control the first leveling member 4 to be raised.

Step S12, after the first leveling member 4 is raised, the trolley 2 is driven under the first modular cleanroom 11, and the first leveling member 4 is lowered until the first modular cleanroom 11 is supported on the trolley 2. Once the position sensor detects that the trolley 2 has been placed at a predetermined position below the first leveling member 4, the controller controls the first leveling member 4 to be lowered to support the first modular cleanroom 11 with the trolley 2.

Step S13, the second leveling member 5 is raised, and the trolley 2 completely carries the first modular cleanroom 11, and the trolley 2 can transport the first modular cleanroom 11 to a designated position.

Step S20, on the trolley 2, the first modular cleanroom 11 is leveled by the first leveling member 4, and the first modular cleanroom 11 is horizontal on the whole. The levelness of the first modular cleanroom 11 may be determined by other means such as a level meter and communicated to the controller. By the operation of S20, it is possible to ensure that the first modular cleanroom 11 becomes horizontal.

Step S30, on the trolley 2, the height of the first modular cleanroom 11 is adjusted to be consistent with that of the second modular cleanroom 12 by the first leveling member 4. Since the first modular cleanroom 11 has become horizontal after step S20, through the operation of step S30, the first modular cleanroom 11 is adjusted to a height consistent with that of the second modular cleanroom 12 while maintaining the horizontal state, and the first modular cleanroom 11 enters into a state ready to be docked with the second modular cleanroom 12.

Step S40, the first modular cleanroom 11 is docked with the second modular cleanroom 12; docking may be performed using the latch provided on the modular cleanroom, such as the latch 3 shown in FIG. 4. The latch locks the docked two modular cleanrooms together. The sealing docking of the two modular cleanrooms ensures the overall sealing of the cleanroom system.

Step S50, the second leveling member 5 is lowered to support the first modular cleanroom 11 on the ground. The second leveling member 5 is lowered while maintaining the leveling state of the first modular cleanroom 11 and after the docking of the first modular cleanroom 11 and the second modular cleanroom 12 is completed. Once the second leveling member 5 is lowered, the first modular cleanroom 11 is fully supported by the second leveling member 5 instead of being supported by the first leveling member 4, and the first leveling member 4 can be raised, and the trolley 2 can disengage from the first leveling member 4, stand by or leave the first modular cleanroom 12 and ready for the next task.

In heavy equipment, leveling pads are usually located under the bottom corners of the machine, and the height of each leveling pad can be adjusted manually for leveling. In the conventional machine leveling operation, forklifts, automated guided vehicles and other trolleys are usually used to lift the modular cleanroom and raise the leveling pads off the ground and the modular cleanroom can move freely. In this process, the leveling pads of the moved modular cleanroom inevitably change their positions, and the level conditions of the ground at different positions are usually different, which makes the original leveling state of the moved modular cleanroom invalid. When docking or releasing the moved modular cleanroom on the forklift, re-leveling is required. In the prior art, as a forklift usually does not have leveling function and only can make the whole equipment move vertically, it is still necessary to manually adjust the leveling pads eventually, to render the leveling operation complex and inaccurate. Therefore, whether during manual docking or during automatic docking, the alignment of the modular cleanroom can only be ensured by repeatedly and independently adjusting each leveling pad of the modular cleanroom before, during and after docking.

While in the case of the docking method of the modular cleanroom according to the present embodiment, the first leveling member 4 is first controlled to level the first modular cleanroom 11, then the first modular cleanroom 11 is then adjusted to the same height as the second modular cleanroom 12 by the first leveling member 4, and after the first modular cleanroom 11 is docked with the second modular cleanroom 12, the second leveling member 5 is finally used to maintain the leveling state in place of the first leveling member 4. Therefore, the first modular cleanroom 11 can be conveniently leveled, and operators can be freed from complex leveling operations without altering the existing trolley.

In one embodiment, in the case that a supporting platform 21 is provided on the surface of the trolley 2 facing the first modular cleanroom 11 above, and the first leveling member 4 is provided on the supporting platform 21 instead of the leveling plate 6, the step S10 may further include: lowering the first leveling member 4 on the supporting platform 21 of the trolley 2, and after the trolley 2 is driven under the first modular cleanroom 11, raising the first leveling member 4 until the first modular cleanroom 11 is supported on the trolley 2, and then raising the second leveling member 5. The first modular cleanroom 11 is now wholly supported by the second leveling member 5 instead of being supported by the first leveling member 4, and the trolley 2 can lower the first leveling member 4 on the supporting platform 21 and stand by in situ or leave the first modular cleanroom 12 to be ready for the next task.

Since the first leveling member 4 is provided on the supporting platform 21 of the trolley 2 instead of the leveling pad 6 of the modular cleanroom, each modular cleanroom only needs to be provided with a second leveling member 5, and the entire cleanroom system 1 only needs to be provided with one set of first leveling member 4 on the trolley 2. The number of leveling members is further greatly reduced and the complexity of the system is reduced while maintaining the advantages of the docking method of the modular cleanroom of the present application, to reduce the system failure probability and improving the maintenance ease.

Finally, the embodiments of the present application have provided many details for a better understanding of the application by the reader. However, even without these details and various changes and modifications based on the above embodiments, the solutions claimed in the claims of the present application can be substantially realized. Therefore, in practical application, various changes in form and detail may be made to the above embodiments without departing from the spirit and scope of the present application.

1. A docking method of a modular cleanroom comprising:
loading a first modular cleanroom on a trolley, wherein said trolley moves next to a second modular cleanroom;
leveling said first modular cleanroom on said trolley by a first leveling member;
adjusting the height of said first modular cleanroom to be consistent with that of said second modular cleanroom on said trolley by said first leveling member;
docking said first modular cleanroom with said second modular cleanroom; and
lowering said second leveling member, wherein said first modular cleanroom is supported on the ground.

2. The docking method of a modular cleanroom according to claim 1, wherein said step of loading a first modular cleanroom on a trolley comprises:
raising the first leveling member;
after said trolley is driven under said first modular cleanroom, lowering said first leveling member until said first modular cleanroom is supported on said trolley; and
raising the second leveling member.

3. A leveling device comprising:
a leveling plate, a first leveling member, and a second leveling member, wherein
said first leveling member and said second leveling member are both provided on said leveling plate and can level said leveling plate independently of each other; and
a controller communicatively connected with said first leveling member for controlling the lifting and lowering of said first leveling member.

4. The leveling device according to claim 3, wherein said first leveling member includes at least three first levelers, each of which is uniformly arranged in the circumferential direction of said leveling plate;
said second leveling member includes at least three second levelers, each of which is uniformly arranged in the circumferential direction of said leveling plate;
wherein, each leveler of said second leveling member is closer to the periphery of said leveling plate compared to each leveler of said first leveling member.

5. The leveling device according to claim 4, wherein said leveling device comprises:
a motor provided on said leveling plate and communicatively connected with said controller;
a lead screw being in transmission connection with said motor and moving along the axis direction of the lead screw under the drive of said motor; and
a leveling pad provided at the end of said lead screw.

6. The leveling device according to claim 3 further comprising:
a position sensor used for acquiring the position of a trolley, wherein said position sensor is communicatively connected with said controller.

7. A modular cleanroom comprising the leveling device of claim 3, wherein said leveling plate is the bottom plate of the modular cleanroom.

8. A cleanroom system comprising a first modular cleanroom, a second modular cleanroom, and a trolley;
wherein said first modular cleanroom is provided with the leveling device of claim 3 and said leveling plate is the bottom plate of said first modular cleanroom.

9. A cleanroom system comprising a first modular cleanroom, a second modular cleanroom, and a trolley;
wherein said first modular cleanroom is provided with a leveling device and said leveling device comprises:
a leveling plate and a second leveling member provided at said leveling plate, said second leveling member being used for leveling said leveling plate;
wherein said trolley is provided with a supporting platform, a first leveling member is provided at said supporting platform, and said first leveling member is configured for leveling the first modular cleanroom supported on said trolley.

10. The cleanroom system according to claim 9, wherein said first leveling member includes at least three first levelers, each of which is uniformly arranged in the circumferential direction of said supporting platform.
